(19) United States
(12) Patent Application Publication
(10) Pub. No.: US 2024/0331458 A1
(43) Pub. Date: Oct. 3, 2024

(54) INFORMATION PROCESSING APPARATUS AND INFORMATION PROCESSING SYSTEM

(71) Applicant: Honda Motor Co., Ltd., Tokyo (JP)

(72) Inventors: Takumi Kaneko, Tokyo (JP); Shinichiro Goto, Tokyo (JP)

(21) Appl. No.: 18/587,532

(22) Filed: Feb. 26, 2024

(30) Foreign Application Priority Data
Mar. 27, 2023 (JP) 2023-050239

(51) Int. Cl. G07C 5/06; G07C 5/00

(52) U.S. Cl. CPC G07C 5/06; G07C 5/008

(57) ABSTRACT

An information processing apparatus includes a microprocessor. The microprocessor is configured to perform: collecting traveling data of a first vehicle to which a predetermined accessory is detachably attached from the first vehicle via a communication unit; learning a feature related to traveling of the first vehicle by use of the traveling data of the vehicle collected in the collecting in a predetermined period in the past to store feature information indicating the feature into a memory; receiving the traveling data transmitted from the first vehicle or a second vehicle different from the first vehicle as a target vehicle via the communication unit, determining whether the predetermined accessory is attached to the target vehicle, based on the traveling data of the target vehicle and the feature information stored in the memory, and outputting information including a determination result in the determining.

### CROSS-REFERENCE TO RELATED APPLICATION

This application is based upon and claims the benefit of priority from Japanese Patent Application No. 2023-050239 filed on Mar. 27, 2023, the content of which is incorporated herein by reference.

### BACKGROUND OF THE INVENTION

### Field of the Invention

The present invention relates to an information processing apparatus and an information processing system for acquiring information on accessory of a vehicle.

### Description of the Related Art

There has been conventionally known a device that manages vehicle information acquired in real time from a traveling vehicle through a communication network and that distributes necessary information (for example, see JP 2004-310218 A). The device described in JP 2004-310218 A acquires information of the amounts and the temperatures of various types of oil, the voltage of the battery, and the like from operation data of the vehicle, and distributes the acquired information to the owner so that the owner of the vehicle is able to manage replacement timings of them.

By the way, an accessory may be newly attached to a vehicle, or an accessory may be replaced from a standard part to an optional part. However, the information acquired by the device described in JP 2004-310218 A does not include information about accessories. The accessories are attached, replaced, or the like by the vehicle owner or a maintenance factory other than an automobile dealer in some cases. In such cases, it may be difficult for an automobile manufacturer or the automobile dealer to acquire information about whether an accessory is attached or unattached, the type of an attached accessory, and the like.

### SUMMARY OF THE INVENTION

An aspect of the present invention is an information processing apparatus including a microprocessor, a memory coupled to the microprocessor and a communication unit. The microprocessor is configured to perform: collecting traveling data of a first vehicle to which a predetermined accessory is detachably attached from the first vehicle via the communication unit; learning a feature related to traveling of the first vehicle by use of the traveling data of the vehicle collected in the collecting in a predetermined period in the past to store feature information indicating the feature into the memory; receiving the traveling data transmitted from the first vehicle or a second vehicle different from the first vehicle as a target vehicle via the communication unit, determining whether the predetermined accessory is attached to the target vehicle, based on the traveling data of the target vehicle and the feature information stored in the memory, and outputting information including a determination result in the determining.

### BRIEF DESCRIPTION OF THE DRAWINGS

The objects, features, and advantages of the present invention will become clearer from the following description of embodiments in relation to the attached drawings, in which:

FIG. 1 is a diagram illustrating a configuration of an information processing system including an information processing apparatus according to an embodiment of the present invention;

FIG. 2 is a block diagram illustrating a configuration of a substantial part of the in-vehicle terminal, which is mounted on the vehicle;

FIG. 3 is a block diagram illustrating a configuration of a substantial part of the information processing apparatus according to the present embodiment;

FIG. 4 is a block diagram illustrating a configuration of a substantial part of a business entity terminal;

FIG. 5A is a flowchart illustrating an example of the information acquisition processing about the accessory to be performed by the arithmetic unit of the information processing apparatus;

FIG. 5B is another flowchart illustrating an example of the information acquisition processing about the accessory to be performed by the arithmetic unit of the information processing apparatus; and

FIG. 5C is the other flowchart illustrating an example of the information acquisition processing about the accessory to be performed by the arithmetic unit of the information processing apparatus.

### DETAILED DESCRIPTION

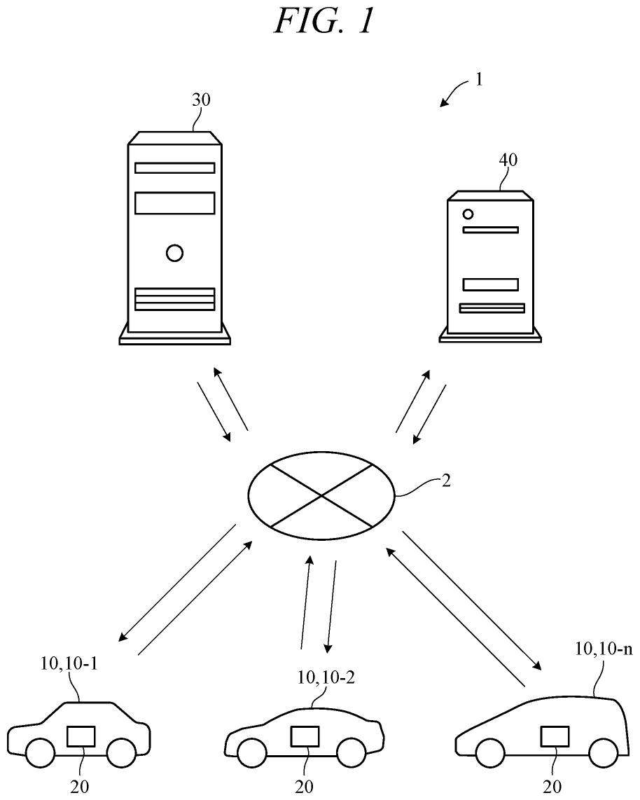

Hereinafter, embodiments of the present invention will be described with reference to FIGS. 1 to 5C. An information processing apparatus according to an embodiment of the present invention is configured as an apparatus that acquires information about accessories including a standard product and an optional product to be attachable to and detachable from a vehicle, for example, the latest information about accessories attached to the vehicle or detached from the vehicle, replaced accessories, and the like. Here, the optional product denotes a component part that is attachable to the vehicle and a component part that can replace a standard component part that has been provided beforehand. The optional product includes a vehicle exterior component part that has been manufactured by an automobile exterior manufacturer, in addition to a genuine component part that has been manufactured by an automobile manufacturer.

In general, in a case where maintenance such as attachment and replacement of accessories attachable to a vehicle is performed by an automobile dealer of an automobile manufacturer, information about the maintenance remains in the automobile manufacturer or the automobile dealer. However, in a case where the vehicle owner, a maintenance factory other than the automobile dealer, or the like attaches or replaces accessories, it is difficult for the automobile manufacturer or the automobile dealer to grasp these pieces of information. Hence, with use of floating car data acquired from a vehicle while the vehicle in which an accessory is attached is traveling, machine learning about features related to traveling of the vehicle in a case where the accessory is attached is performed. Then, the feature obtained by the machine learning is compared with current traveling data of the vehicle, and whether an accessory is attached or unattached to the vehicle is determined. Accordingly, also in a case where the accessory has been attached or the like by the vehicle owner, the maintenance factory other than the automobile dealer, or the like, it is possible to acquire the latest information about the accessory attached to the vehicle. In addition, by transmitting/sharing the latest information about the accessory attached to the vehicle to/with the automobile-related business entities, it can be expected to be useful for future services by the automobile-related business entities. For example, it can be expected to be useful for a case where the vehicle is sold as a used one in the future. The automobile-related business entities include, for example, a used car sales company that sells used cars of the same manufacturer with the automobile dealer, a business enterprise that provides a car sharing service between individuals, and the like. The provision of the car sharing service between individuals refers to business of mediating between an individual owner of a vehicle who wishes to lend the vehicle and a user who wishes to use the vehicle.

FIG. 1 is a diagram illustrating an example of a configuration of an information processing system including an information processing apparatus according to an embodiment of the present invention. As illustrated in FIG. 1, an information processing system 1 includes: an in-vehicle terminal 20, which is mounted on a vehicle 10 to be a management target; an information processing apparatus 30 owned by an automobile dealer that sold the vehicle 10; and a business entity terminal 40 owned by an automobile-related entity related to the automobile dealer.

The in-vehicle terminal 20, the information processing apparatus 30, and the business entity terminal 40 are configured to be capable of communicating with each other through a communication network 2. The communication network 2 includes not only a public wireless communication network represented by the Internet network, a mobile telephone network, or the like but also a closed communication network provided for every predetermined management region, for example, a wireless LAN, Wi-Fi (registered trademark), Bluetooth (registered trademark), or the like.

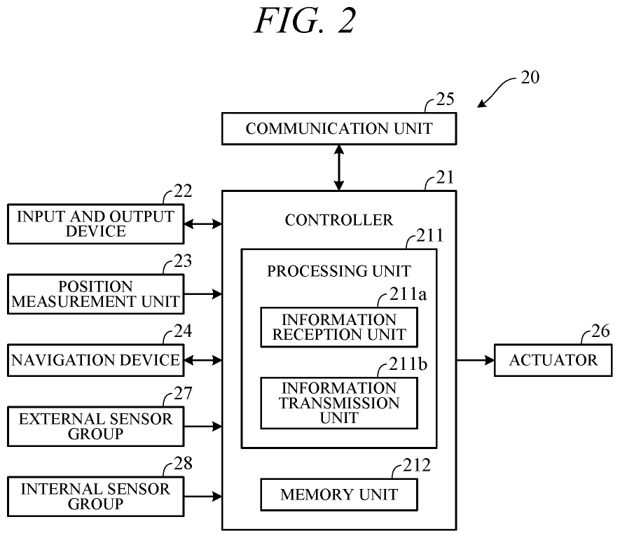

The vehicle 10 to be the management target includes a plurality of vehicles 10-1, 10-2, . . . , 10-n, which have been sold by the automobile dealer, and includes, for example, vehicles that have been purchased on a residual value setting type credit on a precondition of trade-in after several years. FIG. 2 is a block diagram illustrating a configuration of a substantial part of the in-vehicle terminal 20, which is mounted on the vehicle 10. As illustrated in FIG. 2, the in-vehicle terminal 20 mainly includes a controller 21, an input and output device 22, a position measurement unit 23, a navigation device 24, a communication unit 25, an actuator 26, an external sensor group 27, and an internal sensor group 28, which are communicably connected with the controller 21 through a CAN communication line or the like.

The input and output device 22 is a generic term for devices into which a command is input from an occupant of the vehicle 10 or from which information is output to the occupant. For example, the input and output device 22 includes various switches into which the occupant inputs various commands by operating an operation member, a microphone into which the occupant inputs a command by voice, a display for displaying information for the occupant on a display screen, a speaker for providing information for the occupant by voice, and the like.

The position measurement unit (GNSS unit) 23 includes a position measurement sensor for receiving a position measurement signal that has been transmitted from a position measurement satellite. The position measurement sensor can also be included in the internal sensor group 28. The position measurement satellite is an artificial satellite such as a global positioning system (GPS) satellite or a quasi-zenith satellite. The position measurement unit 23 measures a current position (latitude, longitude, altitude) of the vehicle 10 by using the position measurement information that has been received by the position measurement sensor.

The navigation device 24 is a device that searches for a target route on roads to a destination that has been input by the occupant and that guides along the target route. The input of the destination and the guidance along the target route are performed on the input and output device 22. The target route is calculated, based on a current position of the vehicle 10 that has been measured by the position measurement unit 23 and map information stored in a map database.

The communication unit 25 is configured to be capable of wirelessly communicating with external devices such as the information processing apparatus 30 and the business entity terminal 40 through the communication network 2. In addition, the communication unit 25 is configured to be capable of wirelessly communicating with various servers, not illustrated, through the communication network 2 in order to acquire the map information, weather information, traffic information, and the like from these servers regularly or at an optional timing.

The actuator 26 includes a traveling actuator for driving various devices mounted on the vehicle 10 so as to control the traveling of the vehicle 10. For example, the actuator 26 includes the traveling actuator, such as a throttle actuator, a brake actuator, and a steering actuator.

The external sensor group 27 is a generic term for a plurality of sensors (external sensors) that detect a situation in the surroundings (an external situation) of the vehicle 10. For example, the external sensor group 27 includes a LiDAR that detects a position (a distance or a direction from the vehicle 10) of an object in the surroundings of the vehicle 10 by irradiating laser light and detecting reflected light, a radar that detects a position of an object in the surroundings of the vehicle 10 by irradiating electromagnetic waves and detecting reflected waves, and a camera including an imaging element such as a CCD or a CMOS that images the surroundings of the vehicle 10 (forward, rearward, and lateral sides).

The internal sensor group 28 is a generic term for a plurality of sensors (internal sensors) that detect a traveling state of the vehicle 10. For example, the internal sensor group 28 includes a vehicle speed sensor that detects a vehicle speed of the vehicle 10, an acceleration sensor that detects acceleration in a front-rear direction and a left-right direction of the vehicle 10, a rotation speed sensor that detects a rotation speed of a drive source for traveling, and the like. The internal sensor group 28 also includes a sensor that detects a driving operation of a driver, for example, an operation on an accelerator pedal, an operation on a brake pedal, an operation on a steering wheel, and the like, and also includes a sensor that detects a connection signal to be output, when an electric component part included in the accessories is connected to the vehicle 10, a drive signal to be output, when the electric component part is turned on, and the like.

Note that hereinafter, data detected by the external sensor group 27 and the internal sensor group 28, that is, data obtained by an actually traveling vehicle as a sensor (a probe) will be referred to as floating car data (probe data).

The controller 21 includes an electronic control unit (ECU). More specifically, the controller 21 is configured to include a computer including an arithmetic unit 211 such as a CPU (a microprocessor), a storage unit 212 such as a ROM or a RAM, and other peripheral circuits, which are not illustrated, such as an I/O interface. The arithmetic unit 211 includes an information reception unit 211a and an information transmission unit 211b as functional configurations. The storage unit 212 stores various programs executed by the arithmetic unit 211, and also stores various data to be used by the arithmetic unit 211, for example, various type of information that have been detected by the external sensor group 27 and the internal sensor group 28, a map database used by the navigation device 24, and the like.

The information reception unit 211a receives various types of information that have been detected by the external sensor group 27 and the internal sensor group 28, various types of information transmitted from external devices or various servers, not illustrated, and the like through the communication unit 25. More specifically, the information reception unit 211a receives the floating car data from the external sensor group 27 and the internal sensor group 28, and receives the map information, the weather information and the traffic information including date and time, and the like from various servers.

The information transmission unit 211b transmits various types of information to an external device such as the information processing apparatus 30 via the communication unit 25. More specifically, the information transmission unit 211b transmits various data including the floating car data that has been received by the information reception unit 211a to the information processing apparatus 30 via the communication unit 25 in real time.

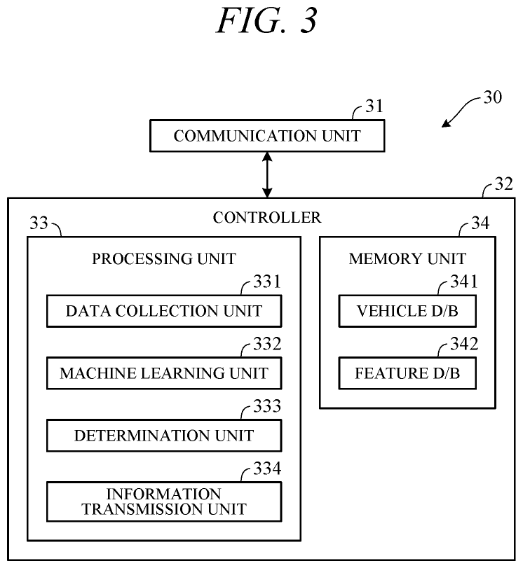

FIG. 3 is a block diagram illustrating a configuration of a substantial part of the information processing apparatus 30 according to the present embodiment. The information processing apparatus 30 is a terminal managed by the automobile dealer who sold the vehicle 10, and includes, for example, a server apparatus. Note that the information processing apparatus 30 may be a terminal managed by a business entity other than the automobile dealer who sold the vehicle 10. For example, the terminal may be a terminal managed by the automobile manufacturer, or may be a terminal managed by the automobile manufacturer and the automobile dealer. In addition, it is possible to configure the information processing apparatus 30 with use of a virtual server function on a cloud, or it may be configured to be distributed on a plurality of terminals. For example, with use of the virtual server function, the storage unit may be provided in another terminal in a distributed manner.

As illustrated in FIG. 3, the information processing apparatus 30 mainly includes: a controller 32; and a communication unit 31, which is electrically connected with the controller 32. The communication unit 31 is configured to be capable of wirelessly communicating with external devices such as the in-vehicle terminal 20 and the business entity terminal 40 through the communication network 2. In addition, the communication unit 31 is configured to be capable of wirelessly communicating with various servers, not illustrated, through the communication network 2 in order to acquire the map information, the weather information, the traffic information, and the like from these servers regularly or at an optional timing.

The controller 32 includes a computer including an arithmetic unit 33 such as a CPU (a microprocessor), a storage unit 34 such as a ROM, a RAM, or a hard disk, and other peripheral circuits, not illustrated, such as an I/O interface. The arithmetic unit 33 includes a data collection unit 331, a machine learning unit 332, a determination unit 333, and an information transmission unit 334, as functional configurations.

The data collection unit 331 receives, via the communication unit 31, various data including the floating car data transmitted from the in-vehicle terminal 20 of the vehicle 10 in real time, and collects the data. More specifically, the data collection unit 331 receives, in real time, data related to traveling such as an external situation and a traveling state of the vehicle 10 that have been received by the external sensor group 27 and the internal sensor group 28 of the in-vehicle terminal 20, and data related to traveling conditions such as the weather information and the traffic information including date and time when the in-vehicle terminal 20 received the data from various servers, stores the received data in the storage unit 34, and collects the data. In this situation, the data collection unit 331 collects the data related to the traveling of the vehicle 10 for every traveling condition such as the weather while traveling. More specifically, the data collection unit 331 collects the data related to the traveling for every type of weather while traveling, and further subdivides the collected data, based on the date and time, the location, the traffic information, and the like.

Note that the data collection unit 331 may directly receive the data related to the traveling condition of the vehicle 10 such as the weather information and the traffic information including date and time from various servers.

The machine learning unit 332 reads the data that has been collected by the data collection unit 331 from the storage unit 34, and performs machine learning about a feature related to the traveling of the vehicle 10 (hereinafter, simply expressed as a feature of the vehicle 10, in some cases) by using the data that has been read. More specifically, the machine learning unit 332 performs the machine learning about the feature of the vehicle 10 corresponding to each traveling condition from the data related to the traveling that has been collected for every traveling condition, such as the date and time, the location, and the weather while the vehicle 10 is traveling. Then, whether an accessory is attached or unattached and the type of such an accessory are also used as input data for the machine learning. This enables learning about the feature of the vehicle 10, in the case where the accessory is attached, for every type of the accessory under each traveling condition. In this manner, the machine learning unit 332 performs the machine learning about the feature of the vehicle 10 for every traveling condition including whether an accessory is attached or unattached and the type of such an accessory, in addition to the date and time, the location, the weather, and the like while the vehicle 10 is traveling.

The machine learning unit 332 stores information indicating a classified feature (hereinafter, referred to as feature information) of the vehicle 10 in a feature database 342 of the storage unit 34 for every traveling condition. In this situation, in a case where the feature information corresponding to the same traveling condition has already been stored, the feature information is updated.

The determination unit 333 compares the feature information of the vehicle 10 stored in the feature database 342 of the storage unit 34 with the latest data (data related to the traveling and data related to the traveling condition) from the vehicle 10 that has been received by the data collection unit 331, and determines whether an accessory is attached or unattached to the vehicle 10 and the type of such an accessory attached to the vehicle 10. Note that the accessory includes an electric component part such as a navigation device and a fog lamp, an exterior component part such as an aero part, a muffler, and the like.

For example, in a case where the traveling condition indicated by the latest data from the vehicle 10 is “weather: foggy” and in determining whether a fog lamp is attached or unattached to the vehicle 10, based on the latest data, the determination unit 333 reads feature information corresponding to the traveling conditions “weather: foggy”, “accessory: attached”, and “accessory type: fog lamp” from the feature database 342. Then, the determination unit 333 determines whether an accessory is attached or unattached to the vehicle 10, based on the latest data from the vehicle 10 and the feature information that has been read. Specifically, the determination unit 333 compares the feature related to the traveling of the vehicle 10 indicated by the latest data with the feature related to the traveling of the vehicle 10 indicated by the feature information that has been read from the feature database 342, and calculates a probability that the fog lamp is unattached (hereinafter, referred to as an unattached probability) based on similarity between the features. The unattached probability may be calculated by use of the machine learning, or may be calculated by another method. In a case where the unattached probability is smaller than a threshold value, the determination unit 333 determines that the fog lamp is attached to the vehicle 10. On the other hand, in a case where the unattached probability is equal to or larger than the threshold value, the determination unit 333 determines that the fog lamp is not attached to the vehicle 10.

The floating car data included in the latest data from the in-vehicle terminal 20 of the vehicle 10 includes information indicating a state (connected or unconnected) of a connection signal (hereinafter, referred to as connection information) of the accessory, or information indicating a state (ON or OFF) of the drive signal (hereinafter, referred to as drive information) of the accessory. Note that the connection information and the drive information are both included in the floating car data in some cases. However, for simplification of description, a case where either the connection information or the drive information is included in the floating car data will be given as an example. The determination unit 333 additionally uses the connection information or the drive information to determine that an accessory is unattached to improve determination accuracy as to whether an accessory is attached or unattached. In the case of a fog lamp, regardless of whether a fog lamp is attached or unattached, the drive information is transmitted from the in-vehicle terminal 20 of the vehicle 10, in some cases. Specifically, even in a case where the fog lamp is not attached to the vehicle 10, the drive information indicating an OFF state is transmitted from the in-vehicle terminal 20, in some cases. In this manner, also in the case where the accessory is unattached, when the latest data from the vehicle 10 includes the connection information or the drive information about the accessory, the determination unit 333 additionally uses the connection information or the drive information to determine that the accessory is unattached. For example, the drive information should indicate the OFF state in the case where the fog lamp is unattached. Therefore, in a case where “unattached” is a determination result as to whether an accessory is attached or unattached that has been obtained based on the feature related to the traveling of the vehicle 10, the determination unit 113 further determines whether the drive information indicates the OFF state. Then, in the case where the determination result as to whether an accessory is attached or unattached is “unattached” and the drive information indicates the OFF state, that is, in a case where the determination result as to whether an accessory is attached or unattached matches the drive information, the determination unit 113 determines that the fog lamp is not attached to the vehicle 10. In order to further improve the determination accuracy of being unattached, in a case where the determination result as to whether an accessory is attached or unattached matches the drive information consecutively a predetermined number of times or more, the determination unit 113 determines that the fog lamp is not attached to the vehicle 10.

In addition, the determination unit 333 may determine whether an exterior component part such as a muffler or an aero part is attached or unattached, based on, for example, whether the speed at the time of ordinary driving has increased (a change has occurred in the vehicle speed). That is, the exterior component part may be included in the accessory determined by the determination unit 333 as to whether the accessory is attached or unattached. The determination unit 333 compares data related to the exterior component parts stored beforehand (the feature in the case where the accessory is attached is converted into data) with the latest data, and calculates the unattached probabilities of them. In a case where the unattached probability equal to or larger than a predetermined threshold (for example, 90%) is calculated consecutively a predetermined number of times or more, the determination unit 333 determines that the exterior component part is unattached.

The determination unit 333 also determines replacement of the accessory. For example, in a case where it was determined that the accessory was not attached in or before a previous determination, and it is determined that the accessory is attached in a current determination, the determination unit 333 determines that the accessory is newly attached. On the other hand, in a case where it was determined that the accessory was not attached in the previous determination, but it was determined that the accessory was attached in a determination immediately before the previous determination and it is determined that the accessory is attached in the current determination, the determination unit 333 determines that the accessory has been replaced.

The information transmission unit 334 transmits the determination result as to whether the accessory is attached to the vehicle 10 that has been determined by the determination unit 333 via the communication unit 31 to the business entity terminal 40. The information transmission unit 334 transmits the determination result as to whether the accessory is attached to the business entity terminal 40 regularly or at an optional timing (for example, in a case where there is a change in an attached situation of the accessory).

The storage unit 34 stores various programs, various data, and the like, to be executed by the arithmetic unit 33. The storage unit 34 also stores, as various types of data to be stored, a vehicle database 341 related to vehicle information, the feature database 342 related to features related to the traveling of every vehicle, and the like. The vehicle database 341 stores owner information including an owner ID of an owner who owns the vehicle 10 and vehicle information including a vehicle ID, which is associated with the owner ID. The owner information includes an address, a name, a contact address, a payment method at the time of purchasing the vehicle, and the like of the owner, which are associated with the owner ID. The vehicle information includes a vehicle type, a model year, a grade, a color, a vehicle body number, a vehicle number, and the like, which are associated with the vehicle ID. In the feature database 342, as described above, features related to the traveling of the vehicle 10 are stored for every traveling condition. Note that the feature database 342 may store a feature related to each traveling for every vehicle. In addition, the feature database 342 may store data related to the exterior component part.

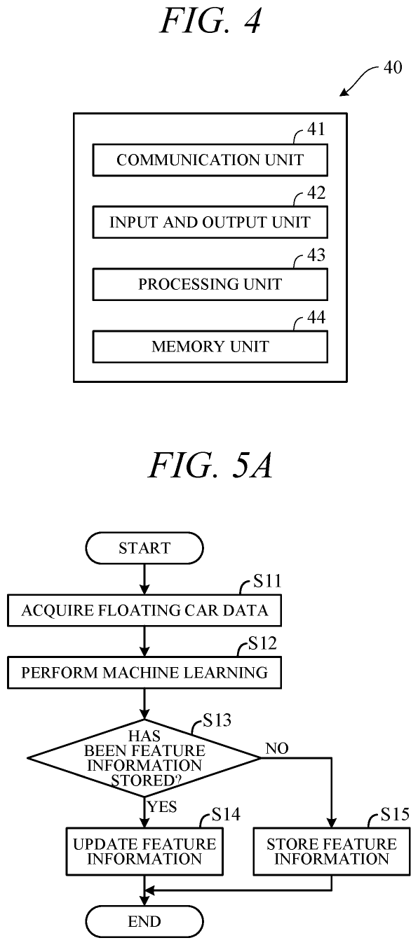

FIG. 4 is a block diagram illustrating a configuration of a substantial part of the business entity terminal 40. The business entity terminal 40 is a terminal owned by an automobile-related business entity having a relationship with an automobile dealer owning the information processing apparatus 30.

The business entity terminal 40 includes, for example, a personal computer. As illustrated in FIG. 4, the business entity terminal 40 includes a communication unit 41, an input and output unit 42, an arithmetic unit 43, and a storage unit 44.

The communication unit 41 is configured to be capable of wirelessly communicating with an external device such as the information processing apparatus 30 through the communication network 2. The input and output unit 42 is a generic term for devices into which a user of the business entity terminal 40 inputs a command into the business entity terminal 40 and from which information is output to the user of the business entity terminal 40. For example, the input and output unit 42 includes various switches into which the user inputs various commands, a display that displays information to the user, and the like. The storage unit 44 stores various programs, various data, and the like, to be executed by the arithmetic unit 43.

The arithmetic unit 43 includes a CPU, performs predetermined processing, based on a signal that has been received from the outside via the communication unit 41, a signal that has been input via the input and output unit 42, and a program or data stored in the storage unit 44, and outputs a control signal to each the communication unit 41, the input and output unit 42, and the storage unit 44. By such processing of the arithmetic unit 43, the information about the accessory of the vehicle 10 transmitted from the information processing apparatus 30 is displayed on the input and output unit (a display) 42, and the user of the business entity terminal 40 is able to confirm this.

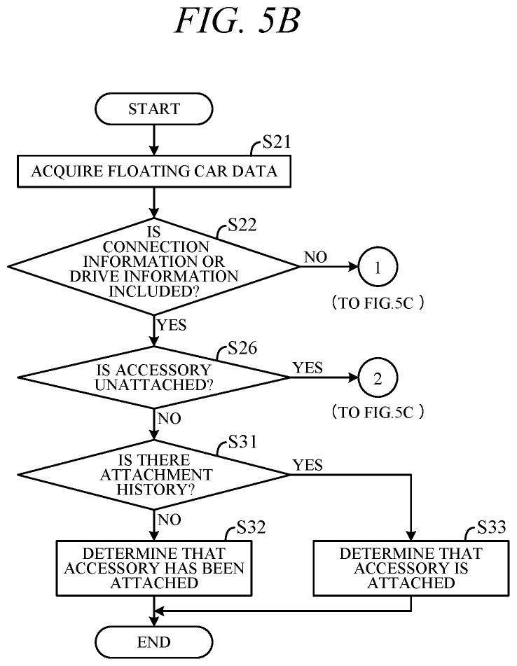

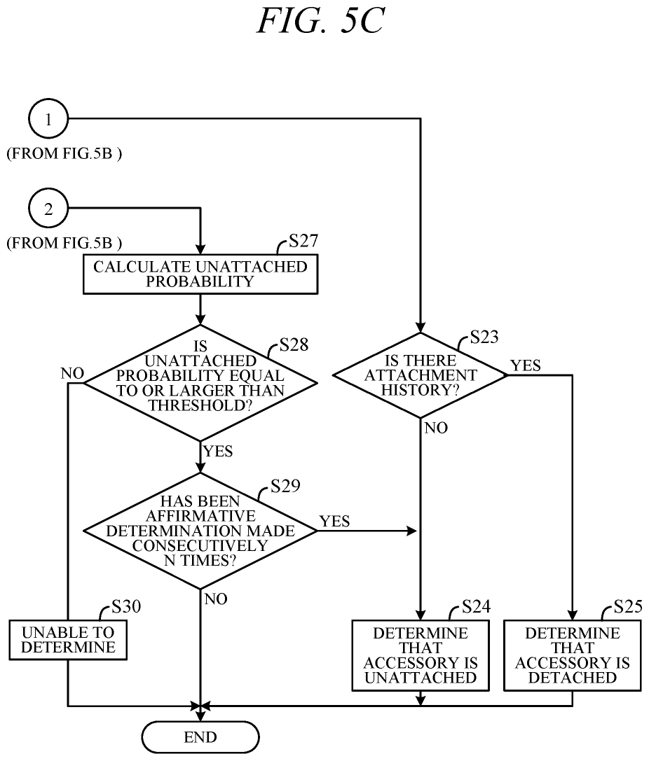

Next, a description will be given with regard to information acquisition processing for acquiring information about the accessory by the information processing apparatus 30 that has been described above. FIGS. 5A, 5B and 5C are flowcharts illustrating an example of the information acquisition processing about the accessory to be performed by the arithmetic unit 33 of the information processing apparatus 30. The processing illustrated in the flowcharts of FIGS. 5A, 5B and 5C is started, for example, when the vehicle 10 that has been sold by the automobile dealer is delivered, and is repeatedly performed, whenever the floating car data transmitted from the vehicle 10 in accordance with actual traveling of the vehicle 10 is received (acquired).

The flowchart of FIG. 5A illustrates construction processing of the feature database 342. First, in step S11, various data including the floating car data transmitted from the in-vehicle terminal 20 of the vehicle 10 (hereinafter, referred to as traveling data) is acquired. In addition to the floating car data, the traveling data includes data related to the traveling condition of the vehicle 10 such as the weather information and the traffic information including date and time that have been received from various servers. Next, in step S12, machine learning about the features related to the traveling of the vehicle 10 is performed with use of the floating car data and the like. Specifically, machine learning about the features related to the traveling of the vehicle 10 is performed from the data related to the traveling that has been collected for every traveling condition such as the date and time, the location, and the weather while the vehicle 10 is traveling.

Next, the feature information indicating the feature related to the traveling of the vehicle 10 learned in step S12 is stored in the feature database 342 of the storage unit 34 (steps S13 to S15). First, in step S13, it is determined whether the feature information corresponding to the same traveling condition with the traveling condition indicated by the traveling data acquired in step S11 has already been stored in the feature database 342. In a case where an affirmative determination is made in step S13, the feature information stored in the feature database 342 is updated in association with the same traveling condition in step S14, based on the feature related to the traveling of the vehicle 10 learned in step S12. In a case where a negative determination is made in step S13, the feature information indicating the feature related to the traveling of the vehicle 10 learned in step S12 is newly stored in the feature database 342 in step S15 in association with the traveling condition indicated by the traveling data acquired in step S11. In the case where the affirmative determination is made in step S13, the feature information is overwritten and updated in step S15.

The flowchart of FIGS. 5B and 5C illustrate determination processing of determining whether an accessory is attached or unattached to the vehicle 10 with use of the feature database 342, which has been constructed by the processing of FIG. 5A. First, in step S21, the traveling data transmitted from the in-vehicle terminal 20 of the vehicle 10 is acquired. In step S22, it is determined whether the connection information (the connection signal) or the drive information (the drive signal) is included in the floating car data included in the traveling data acquired in step S21. In a case where a negative determination is made in step S22, it is determined in step S23 whether there is an attachment history of the accessory. Specifically, it is determined whether an accessory is attached was determined (the accessory was attached to the vehicle 10) in or before a previous cycle. It is determined whether the connection information (or the drive information) has been acquired. In a case where a negative determination is made in step S23, it is determined in step S24 that the accessory is unattached. On the other hand, in a case where an affirmative determination is made in step S23, it is determined in step S25 that the accessory has been detached.

On the other hand, in a case where an affirmative determination is made in step S22, it is determined in step S26 whether the accessory is unattached, based on the connection information or the drive information. Hereinafter, this determination will be referred to as temporary determination or first determination. In a case where the accessory is a fog lamp, it is determined whether the drive information acquired in step S21 indicates the OFF state. In a case where an affirmative determination is made in step S26, the feature information associated with the traveling condition indicated by the traveling data acquired in step S21 is read from the feature database 342 in step S27. Then, the feature indicated by the feature information that has been read is compared with the feature of the vehicle 10 indicated by the traveling data acquired in step S21, and the unattached probability is calculated. As described above, the unattached probability is calculated with use of the machine learning or the like. In step S28, it is determined whether the unattached probability calculated in step S27 is equal to or larger than a threshold. In a case where an affirmative determination is made in step S28, it is determined in step S29 whether the affirmative determination of step S28 has been made consecutively a predetermined number of times (N times). In a case where the affirmative determination is made in step S29, the processing proceeds to step S24, and it is determined that the accessory is unattached. On the other hand, in a case where a negative determination is made in step S29, the processing ends. In a case where a negative determination is made in step S28, it is determined in step S30 that it is not possible to determine whether an accessory is attached or unattached.

In a case where a negative determination is made in step S26, it is determined in step S31 whether there is the attachment history of the accessory. In a case where a negative determination is made in step S31, it is determined in step S32 that the accessory has been attached to the vehicle 10. On the other hand, in a case where an affirmative determination is made in step S31, it is determined in step S33 that the accessory is attached.

The determination results of steps S24, S25, S30, S32, and S33 in FIGS. 5B and 5C are transmitted to the business entity terminal 40 by the information transmission unit 334. Note that the determination unit 113 may further determine whether the accessory has been replaced, based on the determination results of steps S24, S25, S30, S32, and S33, and may transmit a determination result as to whether the accessory has been replaced to the business entity terminal 40. For example, in a case where the determination result that the accessory was attached was obtained in or before a cycle immediately before the previous cycle (S33), the determination result that the accessory was detached was obtained in the previous cycle (S25), and the determination result that the accessory is attached is obtained in the current cycle (S32), the determination unit 113 is capable of determining that the accessory has been replaced.

The operations of the information processing apparatus 30 according to the present embodiment are summarized as follows. The vehicle 10 is delivered, and the vehicle 10 is actually driven to obtain floating car data. When the floating car data is obtained, the machine learning about features related to the traveling of the vehicle 10 is performed from data including the floating car data (steps S11 to S13). When there is a change between the latest data acquired in real time and the feature obtained by the machine learning, whether an accessory is attached or unattached is to be considered. Therefore, whether the accessory has been attached, detached, replaced, or the like is determined (steps S15 to S23). Then, in a case where it is determined that there is a change in an attached situation of the accessory of the vehicle 10, the information about the accessory is updated, and this information is transmitted to the business entity terminal 40 (steps S24 to S25).

According to the present embodiment, the following operations and effects are achievable.
(1) The information processing apparatus 30 is configured as an apparatus that acquires information about an accessory detachably attached to the vehicle 10 (FIGS. 1 to 3). The information processing apparatus 30 includes: the data collection unit 331 that collects traveling data of the vehicle 10 to which a predetermined accessory is detachably attached; the machine learning unit 332 as a learning unit that learns a feature related to traveling of the vehicle 10 by use of the traveling data of the vehicle 10 that has been collected by the data collection unit 331 in a predetermined period in the past; the determination unit 333 that receives the traveling data transmitted from a target vehicle with the vehicle 10 or a vehicle different from the vehicle 10 as the target vehicle, and that determines whether the predetermined accessory is attached to the target vehicle, based on the traveling data of the target vehicle that has been received and the feature that has been learned by the machine learning unit 332; and the information transmission unit 334 as an output unit that outputs information including a result of the determination unit 333. The information processing apparatus 30 includes: the data collection unit 331 that collects various data in real time, the various data including floating car data detected by each of the external sensor group 27 and the internal sensor group 28, which are mounted on the vehicle 10; the machine learning unit 332 that learns the feature related to the traveling of the vehicle 10 by use of a plurality of data that have been collected by the data collection unit 331; the storage unit 34 that stores the feature of the vehicle 10 that has been learned by the machine learning unit 332; and the determination unit 333 that compares the feature of the vehicle 10 stored in the storage unit 34 with the latest data obtained from the vehicle 10 collected by the data collection unit 331 and that determines whether an accessory is attached or unattached (FIG. 3, FIG. 5A, FIG. 5B and FIG. 5C).

With this configuration, also in a case where the owner of the target vehicle attaches or detaches an accessory, in a maintenance factory, or the like other than an automobile dealer of an automobile manufacturer, the information of attachment or the like can be acquired. That is, as long as the target vehicle is traveling, the latest information of the accessory including an optional product of the target vehicle can be acquired. In addition, by performing machine learning about the accessories including the optional product of the target vehicle by use of the floating car data, the information about the accessory can be easily acquired.
(2) The determination unit 333 calculates an unattached probability indicating a degree of a possibility that the predetermined accessory is unattached to the target vehicle, based on the traveling data of the target vehicle and the feature that has been learned by the machine learning unit 332, and determines that the predetermined accessory is unattached to the target vehicle, in a case where the unattached probability that has been calculated is equal to or larger than a threshold. More specifically, in a case where the unattached probability equal to or larger than the threshold is calculated consecutively a predetermined number of times or more, the determination unit 333 determines that the predetermined accessory is not attached to the target vehicle. In this manner, by calculating the unattached probability of the accessory in the target vehicle by use of the floating car data, it becomes possible to determine whether an accessory is attached or unattached.
(3) The determination unit 333 determines whether the traveling data of the target vehicle includes state information (the connection information or the drive information) indicating an ON or OFF state of a signal indicating that the predetermined accessory is connected or driven. In a case where the state information is not included, the determination unit 333 determines that the predetermined accessory is not attached to the target vehicle. In a case where the state information is included, the determination unit 333 makes a first determination as to whether the predetermined accessory is attached to the target vehicle, based on the state information. In a case of determining that the predetermined accessory is not attached to the target vehicle in the first determination, the determination unit 333 further makes a final determination as to whether the predetermined accessory is attached to the target vehicle, based on the unattached probability. With this configuration, whether an accessory such as an electric component part is attached or unattached can be determined with higher accuracy.
(4) The traveling data of the vehicle 10 and the traveling data of the target vehicle include data related to the traveling including a vehicle speed, and data related to a traveling condition including date and time and weather. With this configuration, whether an accessory is attached or unattached to the target vehicle can be appropriately determined regardless of the traveling condition.
(5) The information processing system includes: the above-described information processing apparatus 30; and the business entity terminal 40 owned by an entity that provides services related to automobiles, and the information transmission unit 334 of the information processing apparatus 30 transmits a determination result of the determination unit 333 to the business entity terminal 40 (FIG. 1).

With this configuration, it becomes possible to share the information about the accessory of the target vehicle between the information processing apparatus 30 and the business entity terminal 40. Therefore, it can be expected to be useful for future services of an automobile-related business entity. For example, for a used car sales company that is an example of an automobile-related business entity, when the target vehicle is sold as a used car in the future, it can be expected that the target vehicle can be secured early in accordance with conditions of accessories. By updating the vehicle information with the latest accessory information of the accessories, the company that mediates a car-sharing service is easily found in the search by users who desire to use the car-sharing service, so that it can be expected to facilitate use of the service.

The above embodiments can be modified into various forms. Hereinafter, modifications will be described.

In the above embodiment, the description has been given with regard to a case where the data related to the traveling of the vehicle 10 is collected for every traveling condition related to the weather such as foggy, and the machine learning about features of the vehicle 10 is performed for every traveling condition. However, in addition to the traveling condition related to the weather, the type of a road such as a general road, an expressway, a mountain road, and a road in a living area, may be included in the traveling conditions.

In the above embodiment, an example of acquiring the information about the fog lamp has been described as an example of the information acquisition processing for the accessory. However, the information about the accessory to be acquired is not limited to this, and may be, for example, information about standard equipment (a battery, a headlight, a bumper, or the like) of the vehicle. For example, in the case of a headlight, in a case where the latest vehicle speed at night is faster than the feature obtained by machine learning, an attached probability of the headlight with a large light amount may be calculated.

The above embodiment can be combined as desired with one or more of the above modifications. The modifications can also be combined with one another.

According to the present invention, the information about an accessory detachably attached to a vehicle can be obtained.

Above, while the present invention has been described with reference to the preferred embodiments thereof, it will be understood, by those skilled in the art, that various changes and modifications may be made thereto without departing from the scope of the appended claims.

What is claimed is:

1. An information processing apparatus comprising
a microprocessor, a memory coupled to the microprocessor and a communication unit, wherein
the microprocessor is configured to perform:
collecting traveling data of a first vehicle to which a predetermined accessory is detachably attached from the first vehicle via the communication unit;
learning a feature related to traveling of the first vehicle by use of the traveling data of the first vehicle collected in the collecting in a predetermined period in the past to store feature information indicating the feature into the memory;
receiving the traveling data transmitted from the first vehicle or a second vehicle different from the first vehicle as a target vehicle via the communication unit,
determining whether the predetermined accessory is attached to the target vehicle, based on the traveling data of the target vehicle and the feature information stored in the memory, and
outputting information including a determination result in the determining.

2. The information processing apparatus according to claim 1, wherein
the microprocessor is configured to perform
the determining including calculating an unattached probability indicating a degree of a possibility that the predetermined accessory is unattached to the target vehicle, based on the traveling data of the target vehicle and the feature information stored in the memory to determine that the predetermined accessory is unattached to the target vehicle, in a case where the unattached probability is equal to or larger than a threshold.

3. The information processing apparatus according to claim 2, wherein
the microprocessor is configured to perform
the determining including, in a case where the traveling data of the target vehicle includes state information indicating an ON or OFF state of a signal indicating that the predetermined accessory is connected or driven, determines whether the predetermined accessory is attached to the target vehicle based on the state information and the unattached probability.

4. The information processing apparatus according to claim 3, wherein
the microprocessor is configured to perform
the determining including determining whether the state information is included in the traveling data of the target vehicle, determining, in a case where the state information is not included, that the predetermined accessory is not attached to the target vehicle, performing, in a case where the state information indicating the OFF state of the signal is included, a first determination as to whether the predetermined accessory is attached to the target vehicle, and performing, in a case of determining that the predetermined accessory is not attached to the target vehicle in the first determination, a final determination as to whether the predetermined accessory is attached to the target vehicle based on the unattached probability.

5. The information processing apparatus according to claim 2, wherein
the microprocessor is configured to perform
the determining including, in a case where the unattached probability equal to or larger than the threshold is calculated consecutively a predetermined number of times or more, determining that the predetermined accessory is not attached to the target vehicle.

6. The information processing apparatus according to claim 1, wherein
the traveling data of the first vehicle and the traveling data of the target vehicle include data related to the traveling including a vehicle speed and data related to a condition including date and time and weather during traveling.

7. An information processing system comprising
the information processing apparatus according to claim 1, and
a business entity terminal owned by an entity providing a service related to an automobile, wherein
the outputting including transmitting the determination result to the business entity terminal via the communication unit.
